(19) United States
(12) Patent Application Publication
(10) Pub. No.: US 2024/0367592 A1
(43) Pub. Date: Nov. 7, 2024

(54) DEVICE HOLDER FOR A VEHICLE SEAT

(71) Applicant: MULLEN TECHNOLOGIES, INC., Brea, CA (US)

(72) Inventors: Kedar Deshmukh, Irvine, CA (US); Robert Huotari, Irvine, CA (US); Marc Papakyriakou, Monrovia, CA (US); Anjana Khanna, Irvine, CA (US)

(21) Appl. No.: 18/379,116

(22) Filed: Oct. 11, 2023

Related U.S. Application Data
(60) Provisional application No. 63/463,392, filed on May 2, 2023.

(51) Int. Cl. B60R 11/02; B60N 3/00

(52) U.S. Cl. CPC B60R 11/02; B60N 3/004; B60R 2011/0015

(57) ABSTRACT

Device holders for the backs of vehicle seats and methods for using the same are provided.

### CROSS REFERENCE TO RELATED APPLICATION(S)

This application claims the benefit of prior filed U.S. Provisional Patent Application No. 63/463,392, filed May 2, 2023, which is hereby incorporated by reference herein in its entirety.

### COPYRIGHT NOTICE

At least a portion of the disclosure of this patent document contains material that is subject to copyright protection. The copyright owner has no objection to the facsimile reproduction by anyone of the patent document or patent disclosure as it appears in the Patent and Trademark Office patent file or records, but otherwise reserves all copyright rights whatsoever.

### TECHNICAL FIELD

This disclosure relates to device holders and, more particularly, to device holders for the backs of vehicle seats and methods for using the same.

### BACKGROUND OF THE DISCLOSURE

Many passenger seats are positioned in a vehicle such that the backs of the seats face other passengers in the vehicle. However, the backs of such seats are often underutilized for providing benefits to the other passengers.

### SUMMARY OF THE DISCLOSURE

This document describes device holders for the backs of vehicle seats and methods for using the same.

For example, a system is provided for holding a device at the back of a vehicle seat, as disclosed herein.

As another example, a method is provided for holding a device at the back of a vehicle seat, as disclosed herein.

As yet another example, a device holder system of a vehicle is provided for use with a portable user device, where the device holder system may include a device compartment at least partially defining a device space, a tray component coupled to the device compartment and movable between at least a first position wherein the tray component at least partially covers an opening of the device space and a second position wherein the tray component does not cover the opening of the device space, and an electrical connector that is configured to electrically couple with the portable user device, wherein the electrical connector is coupled to the device compartment and accessible within the device space when the tray component is in the second position.

As yet another example, a device holder system is provided that may include a device compartment defining a device space, a tray component movable between a first position preventing access to the device space and a second position enabling access to the device space, and an electrical connector at least partially positioned within the device space.

As yet another example, a device holder system of a vehicle is provided for use with a portable user device, where the device holder system may include a device compartment at least partially defining a device space, a cover component coupled to the device compartment and operative to selectively cover an opening to the device space, and an electrical connector within the device space.

This Summary is provided to summarize some example embodiments, so as to provide a basic understanding of some aspects of the subject matter described in this document. Accordingly, it will be appreciated that the features described in this Summary are only examples and should not be construed to narrow the scope or spirit of the subject matter described herein in any way. Unless otherwise stated, features described in the context of one example may be combined or used with features described in the context of one or more other examples. Other features, aspects, and advantages of the subject matter described herein will become apparent from the following Detailed Description, Figures, and Claims.

### BRIEF DESCRIPTION OF THE DRAWINGS

The discussion below makes reference to the following drawings, in which like reference characters may refer to like parts throughout, and in which:

FIG. 1 is a schematic view of an illustrative system that may provide a vehicle management service in accordance with some embodiments of the disclosure;

FIG. 1A is a more detailed schematic view of a subsystem of the system of FIG. 1, in accordance with some embodiments of the disclosure;

FIG. 1B is a more detailed schematic view of a portion of the system of FIG. 1, in accordance with some embodiments of the disclosure;

FIG. 1C is a more detailed schematic view of another portion of the system of FIG. 1, in accordance with some embodiments of the disclosure;

FIG. 2 is a top, rear, right side perspective view of a vehicle with a device holder system, in accordance with some embodiments of the disclosure;

FIG. 2A is a top, front, left side perspective view of a portion of the vehicle of FIG. 2, in accordance with some embodiments of the disclosure;

FIG. 2B is a rear interior view of a portion of the vehicle of FIGS. 2 and 2A, taken from line IIB-IIB of FIG. 2A, in accordance with some embodiments of the disclosure;

FIG. 2C is a top, rear, right side perspective view of a portion of the vehicle of FIGS. 2, 2A, and 2B, with each one of two device holder systems in a first configuration, in accordance with some embodiments of the disclosure;

FIG. 2D is a top, rear, right side perspective view of a portion of the vehicle of FIGS. 2, and 2A-2C, with one device holder system in the first configuration and the other device holder system in a second configuration, in accordance with some embodiments of the disclosure;

FIG. 2E is a top, front, right side perspective view of a portion of the vehicle of FIGS. 2, and 2A-2D, with one device holder system in the first configuration and the other device holder system in the second configuration, in accordance with some embodiments of the disclosure;

FIG. 2F is a top, rear, right side perspective view of a portion of the vehicle of FIGS. 2, and 2A-2E, with one device holder system in the first configuration and the other device holder system in the second configuration, in accordance with some embodiments of the disclosure;

FIG. 2G is a front view of a portion of the vehicle of FIGS. 2, and 2A-2F, with one device holder system in the first configuration and the other device holder system in the second configuration, in accordance with some embodiments of the disclosure;

FIG. 2H is a rear view of a portion of the vehicle of FIGS. 2, and 2A-2G, with one device holder system in the first configuration and the other device holder system in the second configuration, in accordance with some embodiments of the disclosure;

FIG. 2I is a right side view of a portion of the vehicle of FIGS. 2, and 2A-2H, with one device holder system in the first configuration, in accordance with some embodiments of the disclosure;

FIG. 2J is a left side view of a portion of the vehicle of FIGS. 2, and 2A-21, with one device holder system in the second configuration, in accordance with some embodiments of the disclosure;

FIG. 2K is a top view of a portion of the vehicle of FIGS. 2, and 2A-2J, with one device holder system in the first configuration and the other device holder system in the second configuration, in accordance with some embodiments of the disclosure;

FIG. 2L is a bottom view of a portion of the vehicle of FIGS. 2, and 2A-2K, with one device holder system in the first configuration and the other device holder system in the second configuration, in accordance with some embodiments of the disclosure;

FIG. 2M is a rear view of a portion of the vehicle of FIGS. 2, and 2A-2L of a portion of one device holder system, in accordance with some embodiments of the disclosure;

FIG. 2N is a cross-sectional view of a portion of the vehicle of FIGS. 2 and 2A-2M, taken from line IIN-IIN of FIG. 2C, with one device holder system in the second configuration, in accordance with some embodiments of the disclosure;

FIG. 2O is a cross-sectional view of a portion of the vehicle of FIGS. 2 and 2A-2N, similar to FIG. 2N, with one device holder system in the various possible configurations, in accordance with some embodiments of the disclosure; and

FIGS. 2P-FIG. 2T are rear views of a portion of the vehicle of FIGS. 2 and 2A-2O, with one device holder system in various possible configurations, in accordance with some embodiments of the disclosure.

### DETAILED DESCRIPTION OF THE DISCLOSURE

Device holders for the backs of vehicle seats and methods for using the same are provided.

Most people don't carry paper maps anymore that were often stored in conventional seat back compartments or pockets of a vehicle. However, vehicle users do now use portable media devices, such as tablets and smartphones, when traveling in vehicles. These devices vary in size. Also, these can be used by vehicle occupants as entertainment devices while travelling in the vehicle (e.g., in the back seat(s) of a vehicle), but there is often no way to securely position these portable media devices in a vehicle. Also, for vehicle occupants, there is often a way to safely store drink cups in cupholders but there is often no food tray in the vehicle. Device holder systems of this disclosure aim to address these problems.

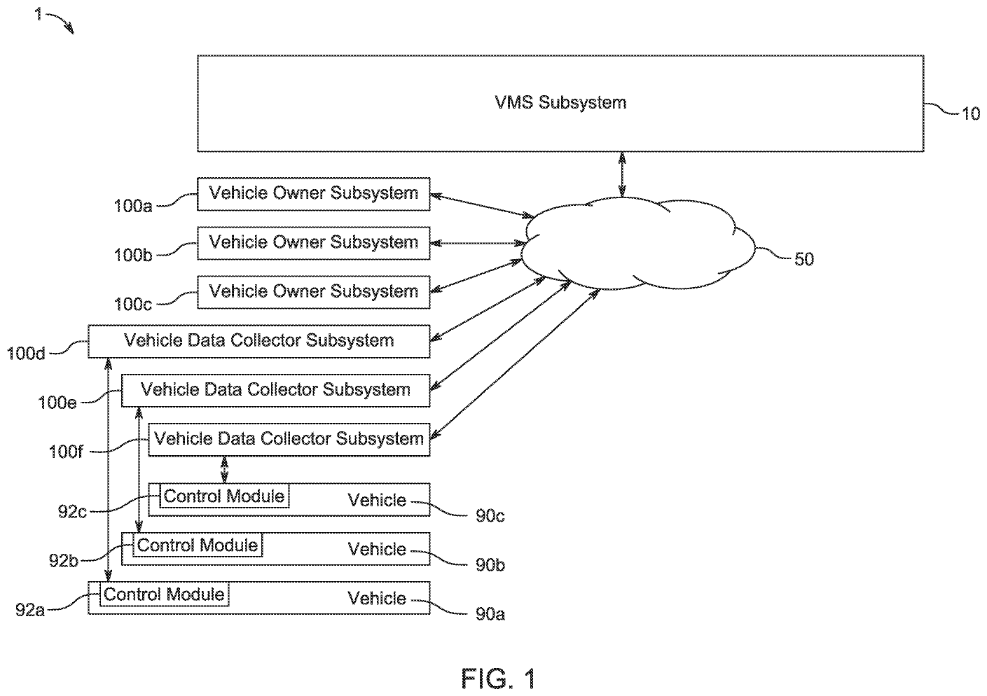

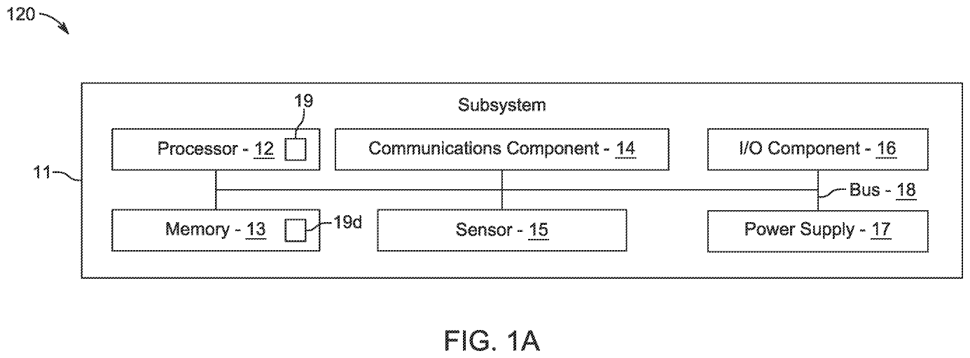

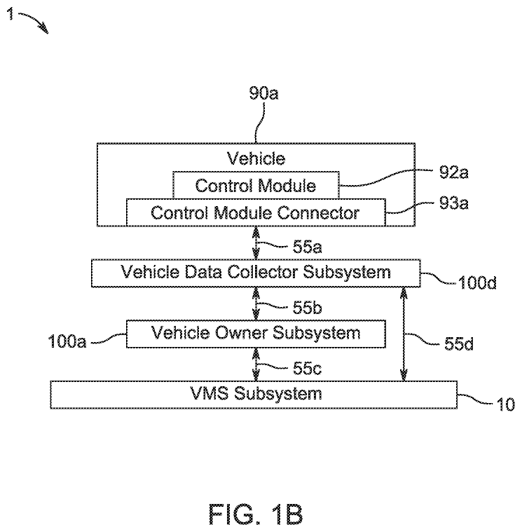

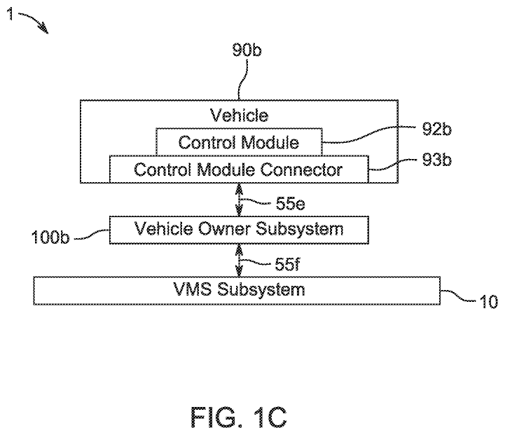

FIG. 1 is a schematic view of an illustrative system 1 in which a vehicle management service, including, but not limited to portable device management, may be facilitated amongst one or more various entities. For example, as shown in FIG. 1, system 1 may include a vehicle management service (“VMS”) subsystem 10, various subsystems 100 (e.g., one or more vehicle owner (“VO”) subsystems 100a-100c, one or more vehicle data collector (“VDC”) subsystems 100d-100f, each of which may be communicatively coupled to one or more control modules (“CMs”) 92 of a respective vehicle 90 (e.g., CMs 92a-92c of respective vehicles 90a-90c that may be owned or operated or managed or controlled by of owners of respective vehicle owner subsystems 100a-100c), and at least one communications network 50 through which any two or more of the subsystems 10 and 100 may communicate. VMS subsystem 10 may be operative to interact with any of the various subsystems 100 to provide a vehicle management service platform (“VMSP”) that may facilitate various vehicle management services, including, but not limited to, managing and enhancing the vehicle ownership process for vehicle buyers, vehicle users, and vehicle sellers for enabling effective and efficient vehicle transactions.

As shown in FIG. 1A, and as described in more detail below, a subsystem 120, which may be any of subsystems 10, 100, and/or modules 92, may include a processor component 12, a memory component 13, a communications component 14, a sensor component 15, an input/output (“I/O”) component 16, a power supply component 17, and/or a bus 18 that may provide one or more wired or wireless communication links or paths for transferring data and/or power to, from, or between various other components of subsystem 120. In some embodiments, one or more components of subsystem 120 may be combined or omitted. Moreover, subsystem 120 may include other components not combined or included in FIG. 1A and/or several instances of the components shown in FIG. 1A. For the sake of simplicity, only one of each of the components of subsystem 120 is shown in FIG. 1A. I/O component 16 may include at least one input component (e.g., button, mouse, keyboard, etc.) to receive information from a user or other device or power therefrom and/or at least one output component (e.g., audio speaker, video display, haptic component, etc.) to provide information or power or any other suitable support to a user or other device, such as a touch screen that may receive input information through a user's touch of a display screen and that may also provide visual information to a user via that same display screen, or an airbag that may be deployed to provide security to one or more passengers of a vehicle user, and/or the like. In some embodiments, an I/O component 16 may be any suitable data and/or power connector (e.g., a Universal Serial Bus (“USB”) connector or any other suitable connector type, a wireless charger (e.g., an inductive charging pad or the like), etc.) that may be utilized in any suitable manner by any suitable portable media device or the like. Memory 13 may include one or more storage mediums or media, including for example, a hard-drive, flash memory, permanent memory such as read-only memory (“ROM”), semi-permanent memory such as random access memory (“RAM”), any other suitable type of storage component, or any combination thereof (e.g., for storing any suitable data (e.g., data 19d)). Communications component 14 may be provided to allow subsystem 120 to communicate with one or more other subsystems 120 (e.g., any communication to/from/between subsystem(s)/module(s) 10, 100, and 92 of system 1) using any suitable communications protocol. Communications component 14 can be operative to create or connect to a communication network or link of a network. Communications component 14 can provide wireless communications using any suitable short-range or long-range communications protocol, such as Wi-Fi (e.g., an 802.11 protocol), Bluetooth, ultra-wideband, radio frequency systems (e.g., 1200 MHZ, 2.4 GHz, and 5.6 GHz communication systems), near field communication (“NFC”), infrared, protocols used by wireless and cellular telephones and personal e-mail devices, or any other protocol supporting wireless communications. Communications component 14 can also be operative to connect to a wired communications link or directly to another data source wirelessly or via one or more wired connections or other suitable connection type(s). Communications component 14 may be a network interface that may include the mechanical, electrical, and/or signaling circuitry for communicating data over physical links that may be coupled to other devices of a network. Such network interface(s) may be configured to transmit and/or receive any suitable data using a variety of different communication protocols, including, but not limited to, TCP/IP, UDP, ATM, synchronous optical networks (“SONET”), any suitable wired protocols or wireless protocols now known or to be discovered, Frame Relay, Ethernet, Fiber Distributed Data Interface (“FDDI”), and/or the like. In some embodiments, one, some, or each of such network interfaces may be configured to implement one or more virtual network interfaces, such as for Virtual Private Network (“VPN”) access.

Sensor 15 may be any suitable sensor that may be configured to sense any suitable data for subsystem 120 (e.g., location-based data via a GPS sensor system, motion data, environmental data, biometric data, etc.). Sensor 15 may be a sensor assembly that may include any suitable sensor or any suitable combination of sensors operative to detect movements of subsystem 120 and/or of any user thereof and/or any other characteristics of subsystem 120 and/or of its environment (e.g., physical activity or other characteristics of a user of subsystem 120, light content of the device environment, gas pollution content of the device environment, noise pollution content of the device environment, altitude of the device, etc.). Sensor 15 may include any suitable sensor(s), including, but not limited to, one or more of a GPS sensor, wireless communication sensor, accelerometer, directional sensor (e.g., compass), gyroscope, motion sensor, pedometer, passive infrared sensor, ultrasonic sensor, microwave sensor, a tomographic motion detector, a camera, a biometric sensor, a light sensor, a timer, or the like. Sensor 15 may include any suitable sensor components or subassemblies for detecting any suitable movement of subsystem 120 and/or of a user thereof. For example, sensor 15 may include one or more three-axis acceleration motion sensors (e.g., an accelerometer) that may be operative to detect linear acceleration in three directions (i.e., the x- or left/right direction, the y- or up/down direction, and the z- or forward/backward direction). As another example, sensor 15 may include one or more single-axis or two-axis acceleration motion sensors that may be operative to detect linear acceleration only along each of the x- or left/right direction and the y- or up/down direction, or along any other pair of directions. In some embodiments, sensor 15 may include an electrostatic capacitance (e.g., capacitance-coupling) accelerometer that may be based on silicon micro-machined micro electro-mechanical systems (“MEMS”) technology, including a heat-based MEMS type accelerometer, a piezoelectric type accelerometer, a piezo-resistance type accelerometer, and/or any other suitable accelerometer (e.g., which may provide a pedometer or other suitable function). Sensor 15 may be operative to directly or indirectly detect rotation, rotational movement, angular displacement, tilt, position, orientation, motion along a non-linear (e.g., arcuate) path, or any other non-linear motions. Additionally or alternatively, sensor 15 may include one or more angular rate, inertial, and/or gyro-motion sensors or gyroscopes for detecting rotational movement. For example, sensor 15 may include one or more rotating or vibrating elements, optical gyroscopes, vibrating gyroscopes, gas rate gyroscopes, ring gyroscopes, magnetometers (e.g., scalar or vector magnetometers), compasses, and/or the like. Any other suitable sensors may also or alternatively be provided by sensor 15 for detecting motion on subsystem 120, such as any suitable pressure sensors, altimeters, or the like. Using sensor 15, subsystem 120 may be configured to determine a velocity, acceleration, orientation, and/or any other suitable motion attribute of subsystem 120 (e.g., a direction and/or strength of an impact (e.g., a crash involving a vehicle 90). One or more biometric sensors may be multi-modal biometric sensors and/or operative to detect long-lived biometrics, modern liveness (e.g., active, passive, etc.) biometric detection, and/or the like. Sensor 15 may include a microphone, camera, scanner (e.g., a barcode scanner or any other suitable scanner that may obtain product identifying information from a code, such as a linear barcode, a matrix barcode (e.g., a quick response (“QR”) code), or the like), proximity sensor, light detector, temperature sensor, motion sensor, biometric sensor (e.g., a fingerprint reader or other feature (e.g., facial) recognition sensor, which may operate in conjunction with a feature-processing application that may be accessible to subsystem 120 for attempting to authenticate a user), line-in connector for data and/or power, and/or combinations thereof. In some examples, each sensor can be a separate device, while, in other examples, any combination of two or more of the sensors can be included within a single subsystem or device. For example, a gyroscope, accelerometer, photoplethysmogram, galvanic skin response sensor, and temperature sensor can be included within a wearable electronic device, such as a smart watch, while a scale, blood pressure cuff, blood glucose monitor, SpO2 sensor, respiration sensor, posture sensor, stress sensor, and asthma inhaler can each be separate devices. While specific examples are provided, it should be appreciated that other sensors can be used and other combinations of sensors can be combined into a single subsystem or device. Subsystem 120 can further include a timer that can be used, for example, to add time dimensions to various attributes of any detected element(s). Sensor 15 may include any suitable sensor components or subassemblies for detecting any suitable characteristics of any suitable condition of the lighting of the environment of subsystem 120. For example, sensor 15 may include any suitable light sensor that may include, but is not limited to, one or more ambient visible light color sensors, illuminance ambient light level sensors, ultraviolet (“UV”) index and/or UV radiation ambient light sensors, and/or the like. Any suitable light sensor or combination of light sensors may be provided for determining the illuminance or light level of ambient light in the environment of subsystem 120 (e.g., in lux or lumens per square meter, etc.) and/or for determining the ambient color or white point chromaticity of ambient light in the environment of subsystem 120 (e.g., in hue and colorfulness or in x/y parameters with respect to an x-y chromaticity space, etc.) and/or for determining the UV index or UV radiation in the environment of subsystem 120 (e.g., in UV index units, etc.). Sensor 15 may include any suitable sensor components or subassemblies for detecting any suitable characteristics of any suitable condition of the air quality of the environment of subsystem 120. For example, sensor 15 may include any suitable air quality sensor that may include, but is not limited to, one or more ambient air flow or air velocity meters, ambient oxygen level sensors, volatile organic compound (“VOC”) sensors, ambient humidity sensors, ambient temperature sensors, and/or the like. Any suitable ambient air sensor or combination of ambient air sensors may be provided for determining the oxygen level of the ambient air in the environment of subsystem 120 (e.g., in O₂% per liter, etc.) and/or for determining the air velocity of the ambient air in the environment of subsystem 120 (e.g., in kilograms per second, etc.) and/or for determining the level of any suitable harmful gas or potentially harmful substance (e.g., VOC (e.g., any suitable harmful gasses, scents, odors, etc.) or particulate or dust or pollen or mold or the like) of the ambient air in the environment of subsystem 120 (e.g., in HG % per liter, etc.) and/or for determining the humidity of the ambient air in the environment of subsystem 120 (e.g., in grams of water per cubic meter, etc. (e.g., using a hygrometer)) and/or for determining the temperature of the ambient air in the environment of subsystem 120 (e.g., in degrees Celsius, etc. (e.g., using a thermometer)). Sensor 15 may include any suitable sensor components or subassemblies for detecting any suitable characteristics of any suitable condition of the sound quality of the environment of subsystem 120. For example, sensor 15 may include any suitable sound quality sensor that may include, but is not limited to, one or more microphones or the like that may determine the level of sound pollution or noise in the environment of subsystem 120 (e.g., in decibels, etc.). Sensor 15 may also include any other suitable sensor for determining any other suitable characteristics about a user of subsystem 120 and/or the environment of subsystem 120 and/or any situation within which subsystem 120 may exist. For example, any suitable clock and/or position sensor(s) may be provided to determine the current time and/or time zone within which subsystem 120 may be located. Sensor 15 may be embedded in a body (e.g., housing 11) of subsystem 120, such as along a bottom surface that may be operative to contact a user, or can be positioned at any other desirable location. In some examples, different sensors can be placed in different locations inside or on the surfaces of subsystem 120 (e.g., some located inside housing 11 and some attached to an attachment mechanism (e.g., a wrist band coupled to a housing of a wearable device), or the like). In other examples, one or more sensors can be worn by a user separately as different parts of a single subsystem 120 or as different subsystems or devices. In such cases, the sensors can be configured to communicate with subsystem 120 using a wired and/or wireless technology (e.g., via communications component 14). In some examples, sensors can be configured to communicate with each other and/or share data collected from one or more sensors.

Power supply 17 can include any suitable circuitry for receiving and/or generating power, and for providing such power to one or more of the other components of subsystem 120. For example, power supply assembly 17 can be coupled to a power grid (e.g., when subsystem 120 is not acting as a portable device or when a battery of the device is being charged at an electrical outlet with power generated by an electrical power plant). As another example, power supply assembly 17 may be configured to generate power from a natural source (e.g., solar power using solar cells). As another example, power supply assembly 17 can include one or more batteries for providing power (e.g., when subsystem 120 is acting as a portable device). Subsystem 120 may also be provided with a housing 11 that may at least partially enclose one or more of the components of subsystem 120 for protection from debris and other degrading forces external to subsystem 120. Each component of subsystem 120 may be included in the same housing 11 (e.g., as a single unitary device, such as a portable media device or server) and/or different components may be provided in different housings (e.g., a keyboard input component may be provided in a first housing that may be communicatively coupled to a processor component and a display output component that may be provided in a second housing, such as in a desktop computer set-up). In some embodiments, subsystem 120 may include other components not combined or included in those shown or several instances of the components shown.

Processor 12 may be used to run one or more applications, such as an application 19 that may be accessible from memory 13 (e.g., as a portion of data 19d) and/or any other suitable source (e.g., from any other device in its system). Application 19 may include, but is not limited to, one or more operating system applications, firmware applications, communication applications (e.g., for enabling communication of data between devices), third party service applications, internet browsing applications (e.g., for interacting with a website provided by a third party subsystem), application programming interfaces (“APIs”), software development kits (“SDKs”), proprietary applications (e.g., a web application or a native application) for enabling subsystem 120 to interact with an online service and/or one or more other subsystems and/or the like, which may include applications for routing protocols, SDN modules based on OpenFlow, P4, or other network data plane programming standards, machine learning algorithms, network management functions, etc., any other suitable applications, such as applications for detecting and reacting to impact on a vehicle and/or detecting and reacting to positioning of travelers and components (e.g., seats, sun roof, etc.) of and within a vehicle (e.g., to adjust the position of any vehicle feature (e.g., sunroof or seat or passenger) and/or deploy an airbag or the like), applications for detecting and reacting to communicative coupling to/decoupling from any suitable portable media device, and/or the like. For example, processor 12 may load an application 19 as an interface program to determine how instructions or data received via an input component of I/O component 16 or other component of subsystem 120 (e.g., sensor 15 and/or communications component 14) may manipulate the way in which information may be stored (e.g., in memory 13) and/or provided via an output component of I/O component 16 and/or communicated to another system device via communications component 14. As one example, application 19 may be a third party application that may be running on subsystem 120 (e.g., an application associated with the network of system 1) that may be loaded on subsystem 120 in any suitable manner, such as via an application market (e.g., using communications component 14), such as the Apple App Store or Google Play, or that may be accessed via an internet application or web browser (e.g., by Apple Safari or Google Chrome) that may be running on subsystem 120 and that may be pointed to a uniform resource locator (“URL”) whose target or web resource may be managed by or otherwise affiliated with any suitable entity. Any subsystem may include any suitable special purpose hardware (e.g., hardware support of high-speed packet processing, hardware support of machine learning algorithms, etc.).

Subsystem 120 may be any portable, mobile, wearable, implantable, or hand-held electronic device configured to operate with system 1. Alternatively, subsystem 120 may not be portable during use, but may instead be generally stationary (e.g., permanently coupled to a vehicle). Subsystem 120 can include, but is not limited to, a media player, video player, still image player, game player, other media player, music recorder, movie or video camera or recorder, still camera, other media recorder, radio, medical equipment, domestic appliance, smart appliance (e.g., smart door knob, smart door lock, etc.), transportation vehicle instrument, musical instrument, calculator, cellular telephone, other wireless communication device, personal digital assistant, remote control, pager, computer (e.g., a desktop, laptop, tablet, server, etc.), monitor, television, stereo equipment, set up box, set-top box, wearable device, boom box, modem, router, printer, kiosk, beacon, server, and any combinations thereof.

In some embodiments, processor 12 may be used to run one or more applications that may be accessible from memory 13 and/or from any other suitable source (e.g., an application from VMS subsystem 10 via an active internet connection or otherwise at and for use by a subsystem 100). Such an application may include, but is not limited to, one or more operating system applications, firmware applications, communication applications, internet browsing applications (e.g., for interacting with a website provided by VMS subsystem 10 for enabling a subsystem 100 to interact with an online service of VMS subsystem 10 (e.g., a VMSP)), VMS applications (e.g., a web application or a native application or a hybrid application that may be at least partially produced by VMS subsystem 10 for enabling a subsystem 100 to interact with an online service of VMS subsystem 10 (e.g., a VMSP)), or any other suitable applications. As one example, an application of a subsystem 100 may provide a user or a communicatively coupled device (e.g., control module 92) with the ability to interact with a vehicle management service or the VMSP of VMS subsystem 10, where such an application may be a third party application that may be running on a subsystem 100 (e.g., an application (e.g., software and/or firmware) associated with VMS subsystem 10 that may be loaded on subsystem 100 from VMS subsystem 10 or via an application market) and/or that may be accessed via an internet application or web browser running on subsystem 100 (e.g., processor 12) that may be pointed to a uniform resource locator (“URL”) whose target or web resource may be managed by VMS subsystem 10 or any other remote subsystem. Each subsystem 100 may be a portable media device (e.g., a smartphone), a laptop computer, a tablet computer, a desktop computer, an appliance, a wearable electronic device, a virtual reality device, a dongle device, at least one web or network server (e.g., for providing an online resource, such as a website or native online application, for presentation on one or more other subsystems) with an interface for an administrator of such a server, and/or the like.

Some or all portions of VMS subsystem 10 may be operated, managed, or otherwise at least partially controlled by an entity (e.g., administrator) responsible for providing a vehicle management service to one or more clients or other suitable entities. VMS subsystem 10 may communicate with one or more subsystems 100 via communications network 50. Network 50 may be the internet or any other suitable network, such that when intercoupled via network 50, any two subsystems of system 1 may be operative to communicate with one another (e.g., a subsystem 100 may access information (e.g., from an application 19 or data 19d of VMS subsystem 10, as may be provided as a vehicle management service via processor 12 and communications component 14 of VMS subsystem 10) as if such information were stored locally at that subsystem 100 (e.g., in its memory component 13)).

Various clients and/or partners may be enabled to interact with VMS subsystem 10 for enabling the vehicle management services and the VMSP. For example, at least one vehicle owner subsystem of system 1 (e.g., each one of the one or more vehicle owner subsystems 100a-100c) may be any suitable subsystem (e.g., portable computer) operated by any suitable vehicle owner (“VO”) that may own, rent, or otherwise have access to a vehicle (e.g., a respective one of the one or more vehicles 90a-90c (e.g., any suitable motor vehicle (e.g., car, truck, bus, motorcycle, etc.), railed vehicle (e.g., train, tram, etc.), watercraft (e.g., ship, boat, jet ski, etc.), aircraft (e.g., airplane, helicopter, drone, etc.), spacecraft, and/or the like)). At least one vehicle data collector subsystem of system 1 (e.g., each one of the one or more vehicle data collector subsystems 100d-100f) may be any suitable subsystem (e.g., dongle device) that may be communicatively coupled to a respective vehicle owner subsystem (e.g., via a network 50) and to a respective control module (e.g., via direct installation) of a respective vehicle (e.g., VDC subsystem 100d may be communicatively coupled to VO subsystem 100a and to CM 92a of vehicle 90a that may be owned by the operator of VO subsystem 100a, VDC subsystem 100e may be communicatively coupled to VO subsystem 100b and to CM 92b of vehicle 90b that may be owned by the operator of VO subsystem 100b, and VDC subsystem 100f may be communicatively coupled to VO subsystem 100c and to CM 92c of vehicle 90c that may be owned by the operator of VO subsystem 100c). For example, a VDC subsystem may be any suitable on-board diagnostics (“OBD”) device that may be operative to be communicatively coupled with any suitable control module of any suitable vehicle (e.g., via any suitable OBD-II data link connector of a vehicle (e.g., via a physical connection or wireless path)) that may be operative to monitor any suitable data from an engine control unit and/or electronic control unit (“ECU”) of the vehicle and/or from any other data source of the vehicle that may be made available (e.g., according to the OBD protocol), such as a powertrain control module (“PCM”) or otherwise. A VDC subsystem may be operative to send one or more requests to the CM of a vehicle for one or more specific parameters using one or more specific parameter identification numbers (“PIDs”) (e.g., according to the Society of Automotive Engineers (“SAE”) standard J1979) and then the VDC subsystem may communicate any received parameter data from the vehicle to a VO subsystem that may be communicatively coupled to the VDC subsystem (e.g., via any suitable wired or wireless communication protocol). For example, as shown in FIG. 1B, VDC subsystem 100d may be communicatively coupled to any suitable control module connector 93a via any suitable communications path 55a, which may be a direct physical connection between connector 93a and a connector of VDC subsystem 100d (e.g., a male connector of an I/O component 16 of VDC subsystem 100d may physically mate with a female control module connector 93a (e.g., any suitable OBD-II data link connector)), where control module connector 93a may be communicatively coupled to one, some, or all suitable control modules or data sources (e.g., control module 92a) of vehicle 90a, while VDC subsystem 100d may be communicatively coupled to VO subsystem 100a via any suitable communications path 55b (e.g., any suitable wired or wireless communications path using any suitable communications protocol (e.g., Bluetooth between a communications component 14 of VDC subsystem 100d and a communications component 14 of VO subsystem 100a), while VO subsystem 100a may be communicatively coupled to VMS subsystem 10 via any suitable communications path 55c (e.g., any suitable wired or wireless communications path (e.g., of network 50 of FIG. 1) using any suitable communications protocol). Alternatively or additionally, as shown in FIG. 1B, VDC subsystem 100d may be communicatively coupled to VMS subsystem 10 via any suitable communications path 55d (e.g., any suitable wired or wireless communications path (e.g., of network 50 of FIG. 1) using any suitable communications protocol (e.g., any suitable long-range communications protocol between a communications component 14 of VDC subsystem 100d and a communications component 14 of VMS subsystem 10 (e.g., using a low power communications component and/or any suitable telemetry functionality)) without VO subsystem 100a as an intermediary. Additionally or alternatively, in some embodiments, a VO subsystem may be configured to communicate directly with a CM of a vehicle without the need for a distinct intermediary VDC subsystem. For example, as shown in FIG. 1C, VO subsystem 100b may be communicatively coupled to any suitable control module connector 93b via any suitable communications path 55e, which may be a direct wired connection between connector 93b and a connector of VO subsystem 100b (e.g., a connector of an I/O component 116 of VO subsystem 100b may be communicatively coupled to a first connector of a cable of communications path 55e and a second connector of such a cable may be communicatively coupled with control module connector 93b (e.g., any suitable OBD-II data link connector)), where control module connector 93b may be communicatively coupled to one, some, or all suitable control modules or data sources (e.g., control module 92b) of vehicle 90b, while VO subsystem 100b may be communicatively coupled to VMS subsystem 10 via any suitable communications path 55f (e.g., any suitable wired or wireless communications path (e.g., of network 50 of FIG. 1) using any suitable communications protocol). In some embodiments, communications path 55e may be a wireless communications path between control module 92b and VO subsystem 100b (e.g., a wireless (e.g., Bluetooth) communication path between a communications component 14 of VO subsystem 100b and a communications component of control module 92b of vehicle 90b), such that a data connection may be facilitated directly between a user's portable electronic device and a computer of a vehicle directly through a wireless connection.

Each subsystem 100 of system 1 (e.g., each one of subsystems 100a-100f) may be operated by any suitable entity for interacting in any suitable way with VMS subsystem 10 (e.g., via network 50) for deriving value from and/or adding value to a service of the VMSP of VMS subsystem 10. For example, a particular subsystem 100 may be a server operated by a client/partner entity that may receive any suitable data from VMS subsystem 10 related to any suitable vehicle management enhancement of the VMSP provided by VMS subsystem 10 (e.g., via network 50). Additionally or alternatively, a particular subsystem 100 may be a server operated by a client/partner entity that may upload or otherwise provide any suitable data to VMS subsystem 10 related to any suitable vehicle management service of the VMSP provided by VMS subsystem 10 (e.g., via network 50).

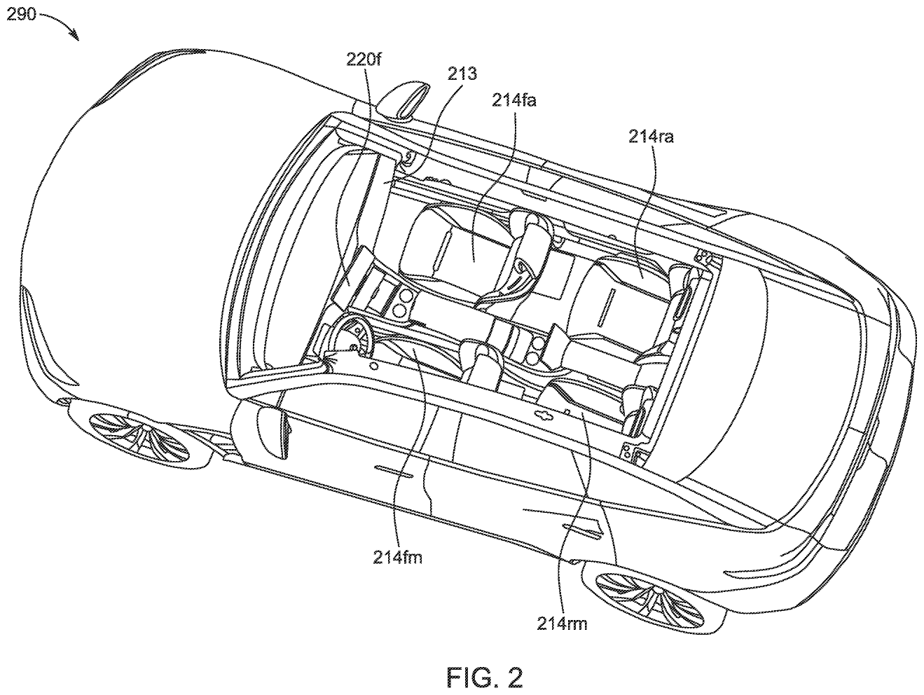

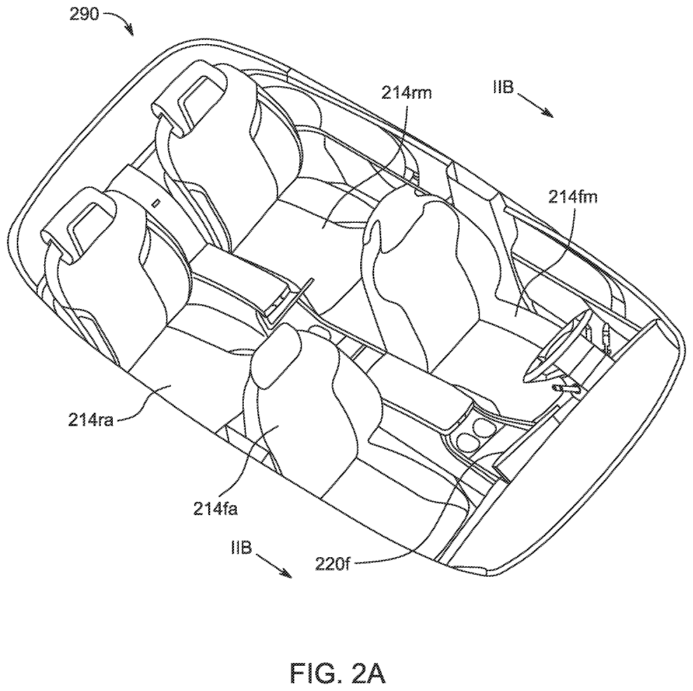

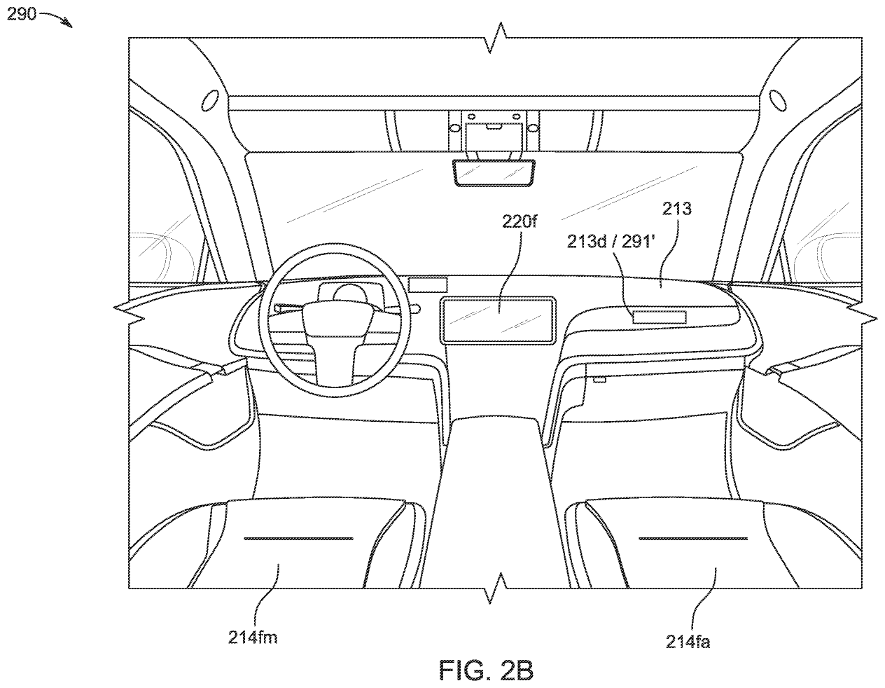

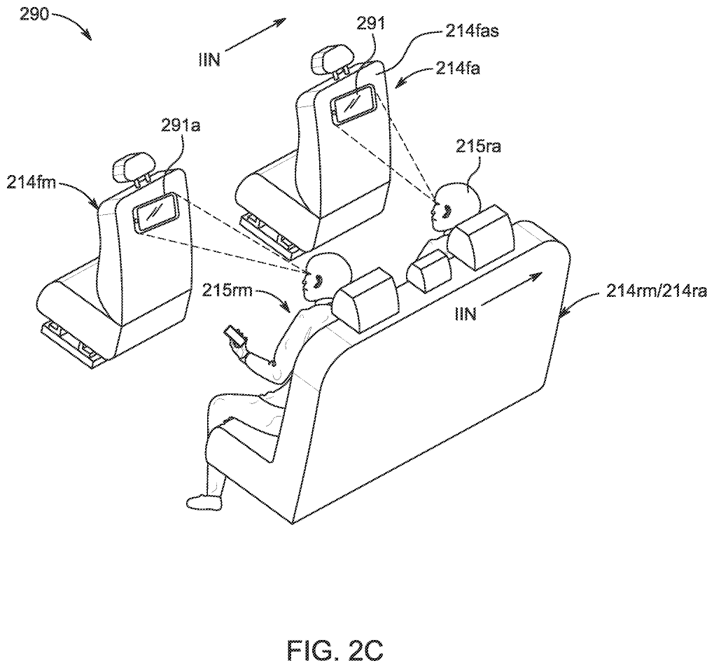

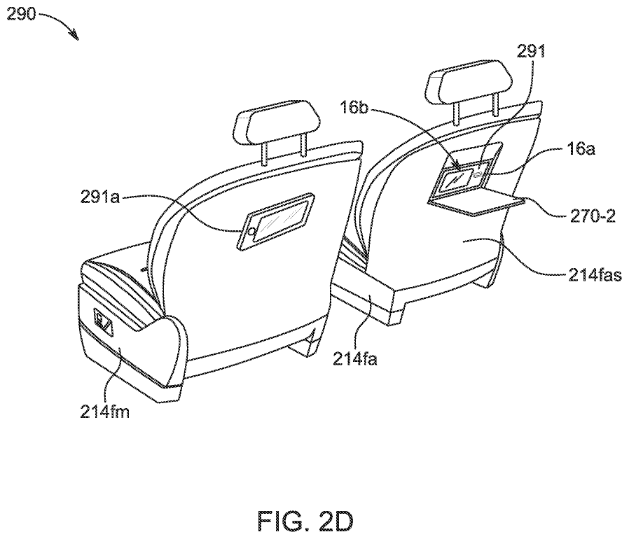

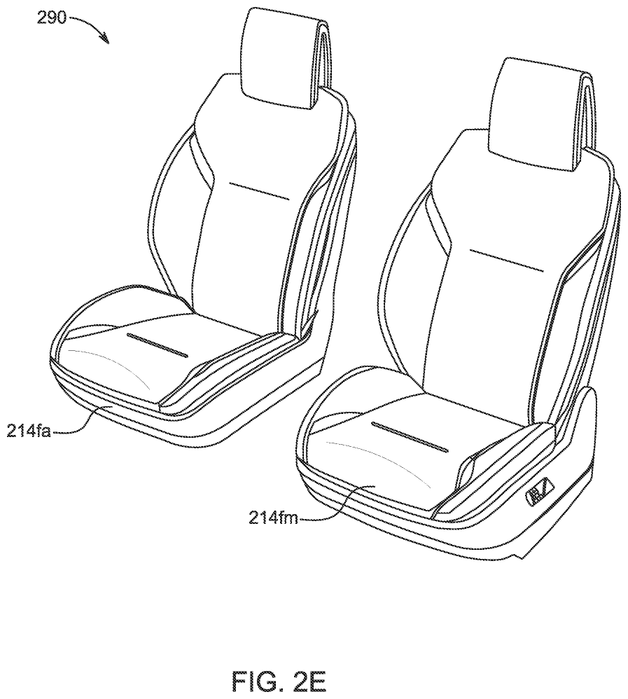

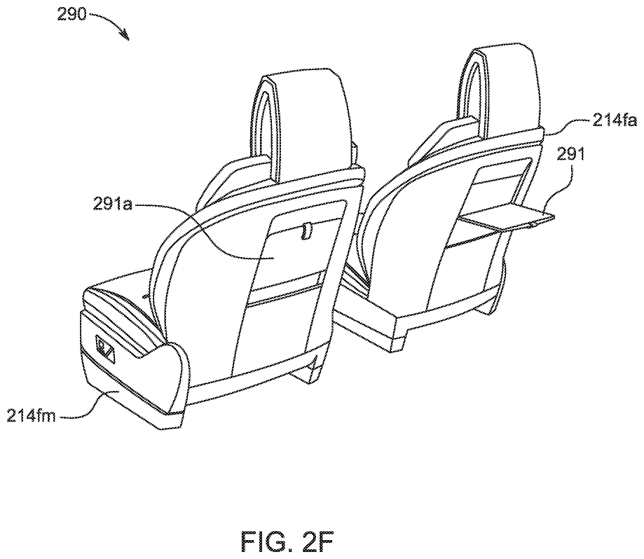

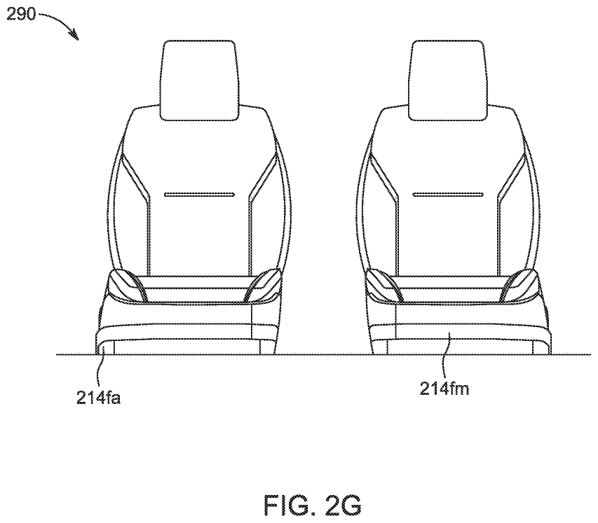

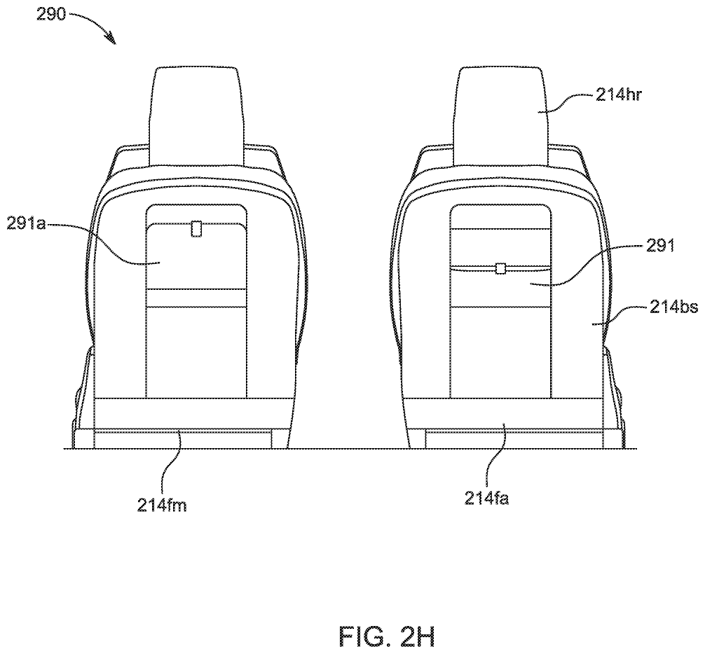

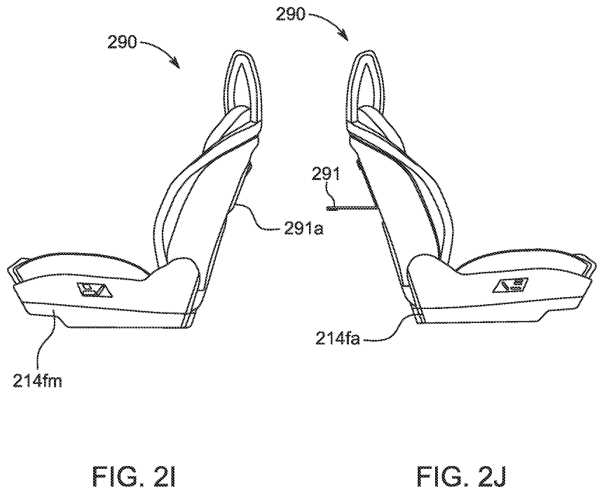

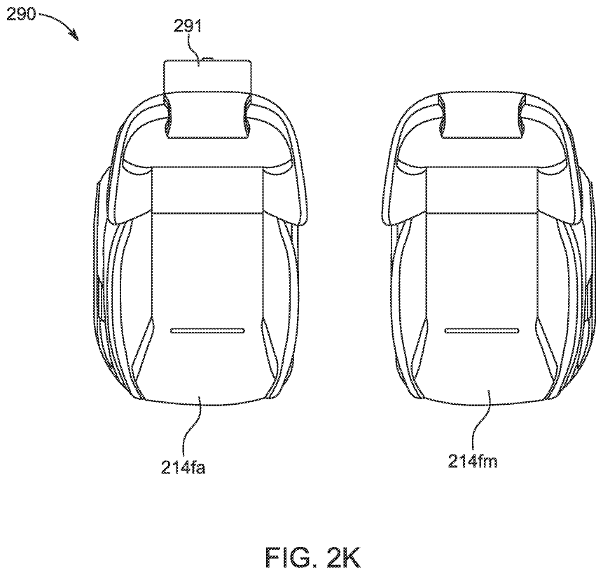

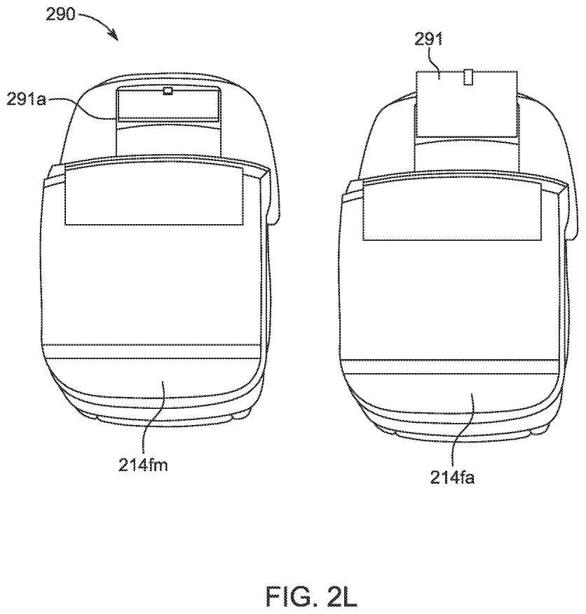

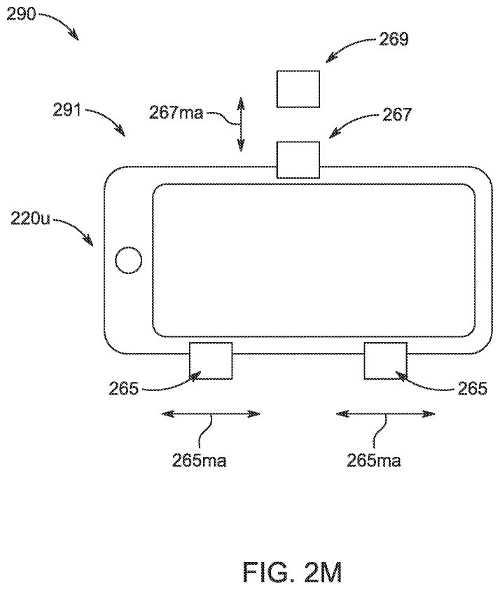

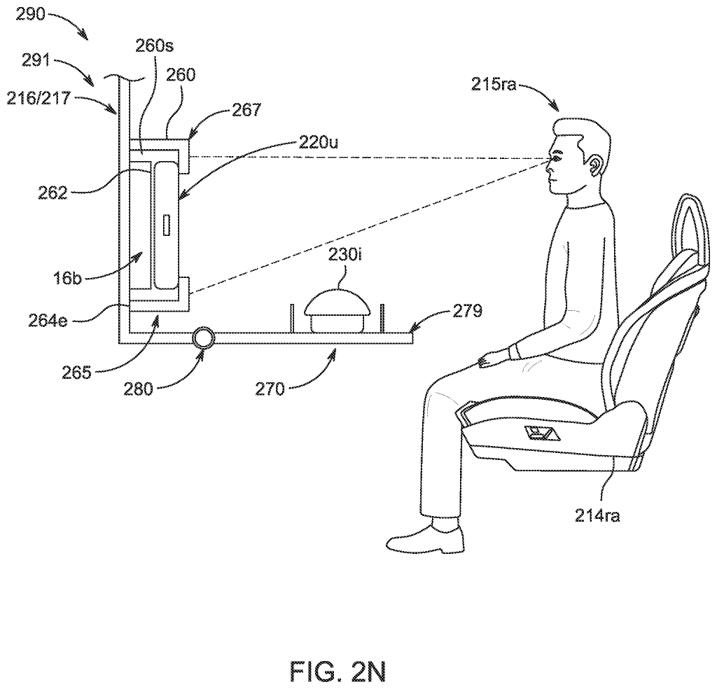

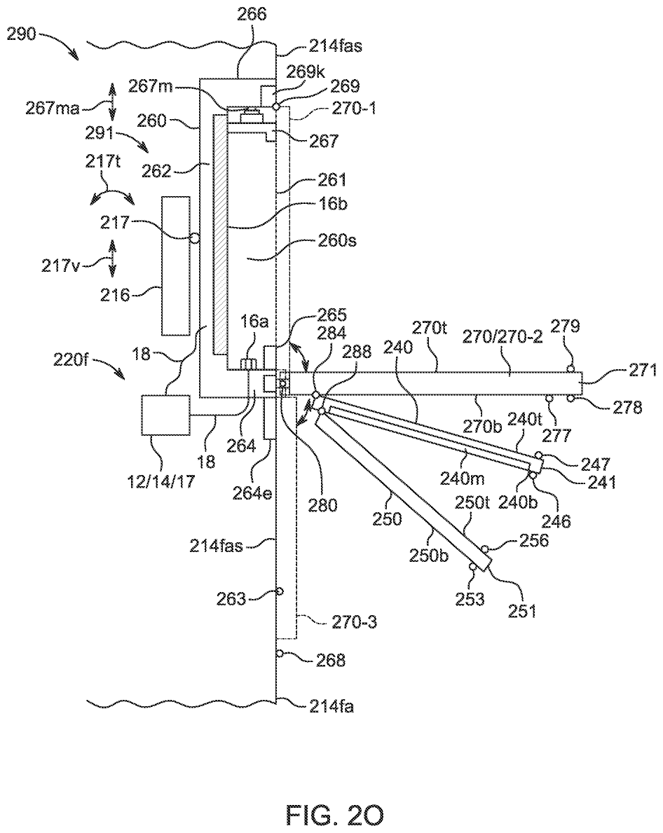

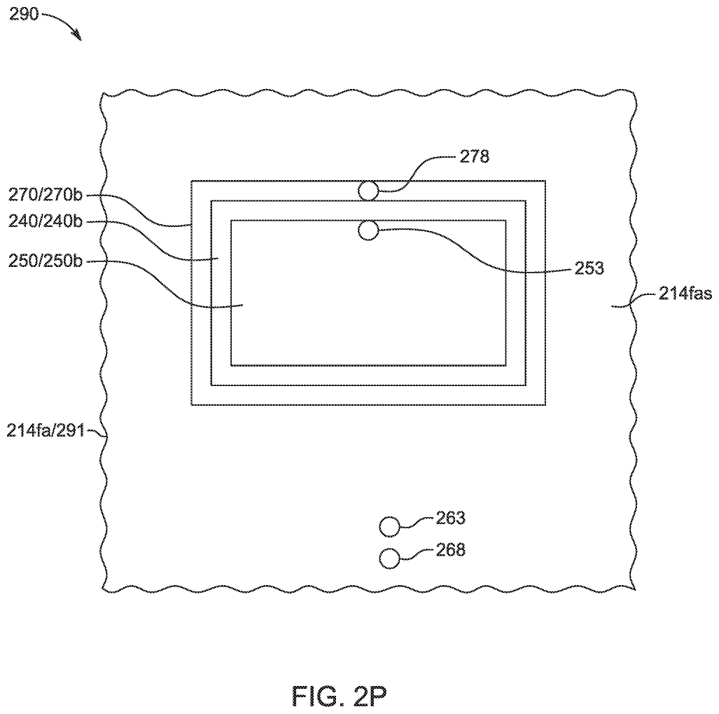

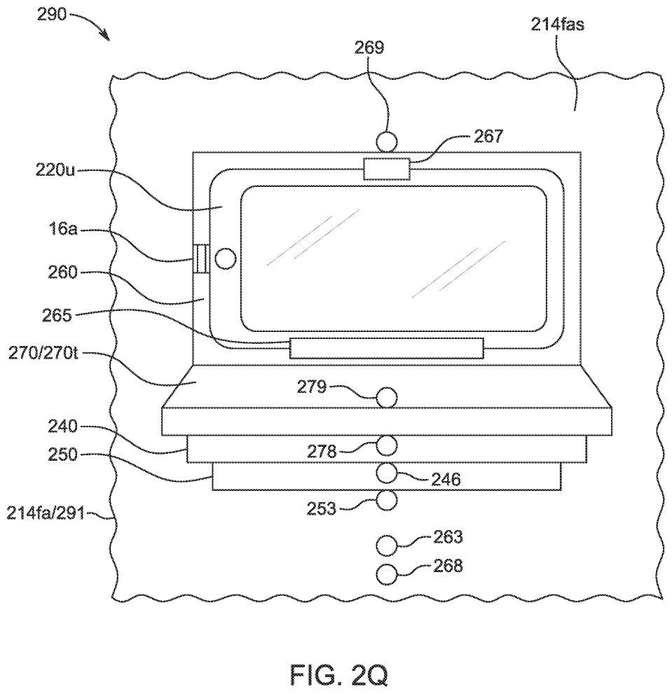

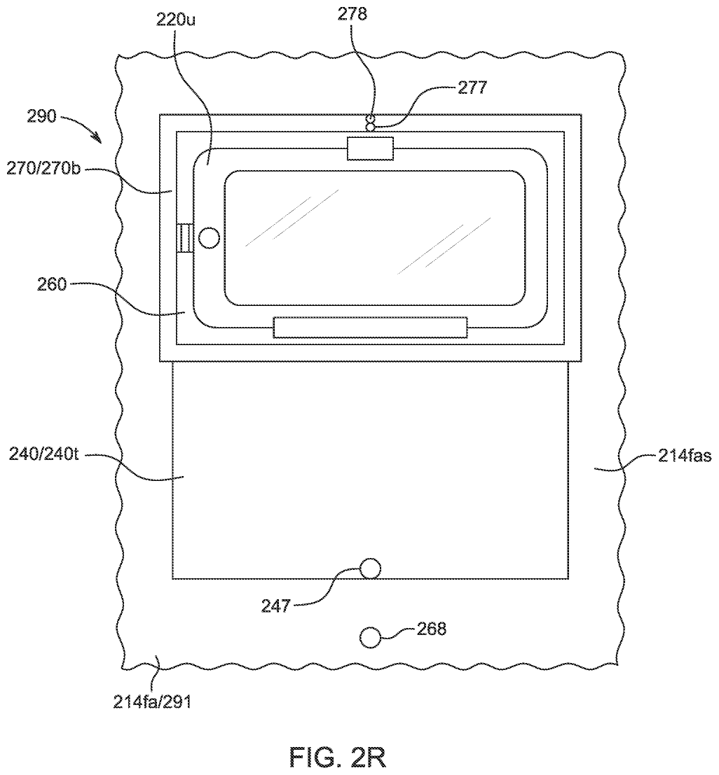

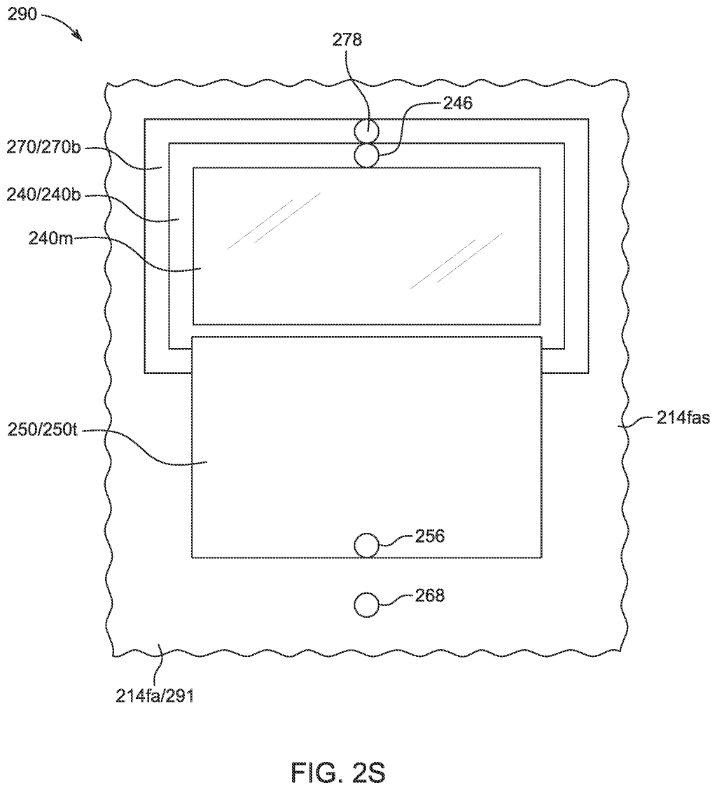

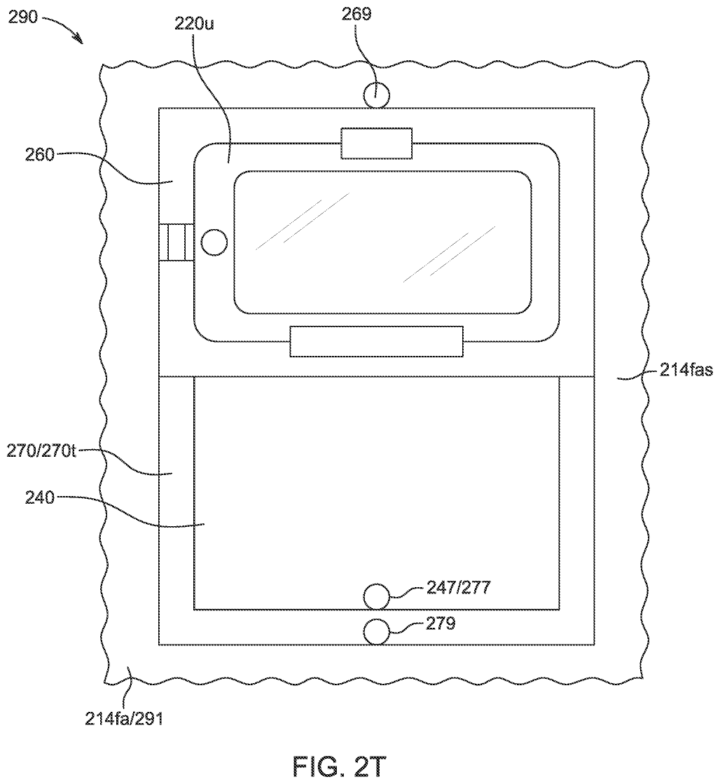

FIGS. 2 and 2A-2D show an illustrative vehicle 290 that may include at least one device holder system 291, in accordance with some embodiments of the disclosure. Vehicle 290 may be any suitable vehicle, which may be similar to any vehicle 90 (e.g., vehicles 90a-90c) described herein. As shown in FIGS. 2 and 2A, in some embodiments, vehicle 290 may be any suitable automobile with at least one seat, which may include at least a front main seat 214fm (e.g., a driver seat if the vehicle is able to be driven) for a front main passenger (not shown). Additionally, in some embodiments, as shown, vehicle 290 may also include a front auxiliary seat 214fa for a front auxiliary passenger (not shown), and at least one rear seat for one or more rear passengers, such as a rear main seat 214rm for a rear main passenger 215rm (see, e.g., FIG. 2C) and/or a rear auxiliary seat 214ra for a rear auxiliary passenger 215ra (see, e.g., FIGS. 2C and 2N). Although each seat for each passenger may be distinct in one or more ways from one another (see, e.g., distinct seats 214rm and 214ra of FIGS. 2 and 2A), any vehicle may be provided with a single seat that may be used simultaneously by two or more adjacent passengers (see, e.g., a bench type rear seat of FIG. 2C). As also shown, vehicle 290 may include at least one vehicle information subsystem 220f similar to any subsystem 120 that may provide a screen user interface for providing any suitable information to one or more passengers of the vehicle (e.g., a screen that may be permanently coupled to vehicle 290 (e.g., to a dashboard or otherwise), such as an infotainment screen, which may be facing or visible or otherwise accessible not only to any passenger(s) of front seat(s) 214fm and/or 214fa but also to any passenger(s) of rear seat(s) 214rm and/or 214ra).

A device holder system may be incorporated into or otherwise provided by or coupled to any suitable seat of any suitable vehicle. For example, as shown, device holder system 291 may be incorporated into or otherwise provided by or coupled to front auxiliary seat 214fa of vehicle 290 (e.g., to a backside or rear portion of seat 214fa that may be facing or visible or otherwise accessible to a passenger of rear auxiliary seat 214ra (e.g., passenger 215ra)). Additionally, in some embodiments, another device holder system 291a may be incorporated into or otherwise provided by or coupled to front main seat 214fm of vehicle 290 (e.g., to a backside or rear portion of seat 214fm that may be facing or visible or otherwise accessible to a passenger of rear main seat 214rm (e.g., passenger 215rm)). Such a device holder system may be provided for holding any suitable user device (e.g., any suitable portable electronic device of a passenger (e.g., a mobile telephone, data assistant, tablet computer, or other such mobile device)) and/or for providing any suitable tray surface (e.g., a tray for supporting food or other suitable user items that a passenger may want easy access to while in the vehicle). For example, as shown, system 291 may include a device compartment 260 that may at least partially define a device space 260s that may be configured to at least partially hold or receive any suitable user device 220u. Moreover, as shown, system 291 may include a tray component 270 that may be movable between and held in various positions (e.g., using any suitable hinge assembly 280) for reconfiguring system 291 between various configurations, such as a first or closed configuration in which tray component 270 may be in an upright position (see, e.g., position 270-1 of FIG. 2O) where tray component 270 may at least partially close or cover an opening (e.g., rear facing opening 261) of device space 260s of device compartment 260 (see, e.g., FIGS. 2P, 2R, 2S for tray 270 of system 291 and FIGS. 2C-2L for system 291a), a second or flat configuration in which tray component 270 may be in an open but flat position (see, e.g., position 270-2 of FIG. 2O) where tray component 270 may not cover an opening of device space 260s of device compartment 260 but may provide a flat or substantially flat or any other suitably angled (e.g., with respect to gravity or otherwise) tray surface (e.g., with at least a portion of top tray surface 270t) for supporting any suitable user item(s) 230i (e.g., food, etc.) and that may extend into a passenger's lap space (see, e.g., FIGS. 2C-2L, 2N, 2O, and 2Q), a third or fully open configuration in which tray component 270 may be in a fully open position (see, e.g., position 270-3 of FIG. 2O) where tray component 270 may not cover an opening of device space 260s of device compartment 260 but may extend along a rear surface of the seat (e.g., so as not to extend into a passenger's lap space (see, e.g., FIG. 2T)), and/or any other configurations therebetween in which tray component 270 may be in any suitable positions between positions 270-1 and 270-2 and/or in any suitable positions between positions 270-2 and 270-3 (e.g., tray 270 in position 270-2 may be rotated substantially 90 degrees (e.g., about a hinge) with respect to position 270-1 and/or rotated substantially 90 degrees (e.g., about a hinge) with respect to position 270-3 (e.g., position 270-1 and position 270-3 may be substantially opposite positions (e.g., 180 degree rotation between the two)). Hinge assembly 280 may be any suitable assembly that may be operative to enable movement of tray component 270 between its various positions and/or to enable retention of tray component 270 in one or more of its various positions (e.g., to hold tray component 270 in its open and flat position 270-2 not only to support the weight of tray component 270 but also any suitable user item(s) 230i that may be placed on a top surface 270t of tray component 270 when in that position). In some embodiments (not shown), a track and pin hinge may be used where a cable may extend from a first end coupled to a left or right side of compartment 260 and a second end that may travel within or with respect to a track that may be provided along the respective left or right side of tray component 270, where the cable may be held taught when the second end of the cable is positioned with a notch at a particular position along the track for holding the tray in the functional flat position 270-2 and where the cable may also allow travel within the track for movement of the tray from position 270-2 to position 270-1 and/or position 270-3.

Device compartment 260 may include a back wall portion 262 that may be opposite opening 261, a bottom wall portion 264, and a top wall portion 266. Any suitable device holding feature(s) may be provided to promote robust retention of any suitable user device (e.g., device 220u) within compartment 260 (e.g., within space 260s) and/or to enable easy withdrawal of such a user device from compartment 260. For example, one or more suitable lower device holding tabs 265 may extend up from bottom wall portion 264 or otherwise, while one or more suitable upper device holding tabs 267 may extend down from top wall portion 266 or otherwise, such that a bottom of user device 220u may be inserted into compartment 260 along bottom wall portion 264 and between back wall portion 262 and lower device holding tab(s) 265, and then a top of user device 220u may be tilted backwards into compartment 260 beyond upper holding tab(s) 267, and then upper holding tab(s) 267 may be manipulated downwards such that the top of user device 220u may be held within compartment 260 between back wall portion 262 and upper holding tab(s) 267. For example, while lower device holding tab(s) 265 may remain still, upper device holding tab(s) 267 may be configured to be manipulated up and down (e.g., along the directions of arrows 267ma by a spring loaded or any other suitable mechanism 267m) to enable the positioning of user device 220u within compartment 260 or removal of user device 220u therefrom when upper device holding tab(s) 267 may be manipulated upwards (e.g., by pushing up against a spring force of mechanism 267m) and to enable the retention of user device 220u within compartment 260 when upper device holding tab(s) 267 may be manipulated downwards (e.g., by the natural spring force of a spring mechanism 267m that may couple upper device holding tab(s) 267 to compartment 260). As another example, while upper device holding tab(s) 267 may remain still such that a top of user device 220u may be inserted into compartment 260 along top wall portion 266 and between back wall portion 262 and upper device holding tab(s) 267, one or more of lower device holding tab(s) 265 may be configured to be manipulated side to side (e.g., along the directions of arrows 265ma by a spring loaded or any other suitable mechanism) to enable the positioning of the bottom of user device 220u within compartment 260 or removal of user device 220u therefrom when lower device holding tab(s) 265 may be manipulated outwardly towards the edges of compartment 260 and to enable the retention of user device 220u within compartment 260 when lower device holding tab(s) 265 may be manipulated inwardly (e.g., by the natural spring force or otherwise of a mechanism that may couple lower device holding tab(s) 265 to compartment 260). However, it is to be understood that any suitable mechanism(s) may be provided by system 291 for enabling the robust retention of any suitable user device (e.g., device 220u) of any suitable size within compartment 260 and/or enabling the easy withdrawal of such a user device from compartment 260. Hinge assembly 280 may be coupled to compartment 260, such as at bottom wall portion 264 (e.g., as shown). Alternatively, hinge assembly 280 may be coupled below bottom wall portion 264 of compartment 260 (or slidable or adjustable to a lower position with respect to compartment 260 or device 220u), such as to a compartment lower extension structure 264e, which may allow for tray component 270 to be held in its functional open position (e.g., flat position 270-2) for supporting any suitable user item(s) 230i without the item(s) 230i obstructing a passenger's line of sight of a user device 220u within compartment 260 (e.g., a much shorter passenger than as shown in FIG. 2N).

When a user device is positioned within compartment 260 of system 291, the user device may be electrically coupled to any other suitable subsystem of vehicle 290. For example, one or more suitable data and/or power connectors (e.g., electrical connectors) may be provided within compartment 260 (e.g., within space 260s) for interacting with user device 220u. In some embodiments, as shown, an I/O component 16a of any suitable vehicle subsystem (e.g., vehicle subsystem 220f) may be any suitable data and/or power connector (e.g., a Universal Serial Bus (“USB”) connector or any other suitable connector type (e.g., male or female)) that may be physically connected or otherwise coupled to a connector (e.g., female or male) of user device 220u when user device 220u is positioned within compartment 260 and/or an I/O component 16b of any suitable vehicle subsystem (e.g., vehicle subsystem 220f) may be any suitable data and/or power connector (e.g., a wireless charger (e.g., an inductive charging pad or the like)) that may be functionally coupled to user device 220u when user device 220u is positioned within compartment 260. As shown, any suitable bus (ses) 18 may communicatively/functionally couple I/O component 16a and/or I/O component 16b to any suitable other components of any suitable vehicle subsystem (e.g., processor 12, communications component 14, and/or power supply 17 of vehicle subsystem 220f). Therefore, when positioned within compartment 260 of device holder system 291, not only may user device 220u be robustly retained within compartment 260, but device 220u may also be coupled to any vehicle subsystem(s) via any suitable I/O component(s) within or adjacent compartment 260 for any suitable purpose(s) (e.g., charging of device 220u and/or synchronization of user device 220u with any vehicle subsystem (e.g., synchronization of a screen of vehicle subsystem 220f with a screen of user device 220u or otherwise)).

Whether or not a user device is positioned within compartment 260 of system 291, any suitable mechanism(s) may be provided for holding tray component 270 in an upright position (see, e.g., position 270-1 of FIG. 2O) that may allow tray component 270 to at least partially close or cover an opening (e.g., rear facing opening 261) of device compartment 260 (see, e.g., FIGS. 2P, 2R, 2S for tray 270 of system 291 and FIGS. 2C-2L for system 291a) and for selectively releasing tray component 270 from such an upright position. For example, as shown, any suitable compartment retention mechanism 269 may be provided at or near a top portion of compartment 260 (e.g., at a rear portion of top wall portion 266), while any suitable tray retention mechanism 279 may be provided at or near a portion of top surface 270t of tray 270 (e.g., at or near a free end 271 of tray 270 opposite hinge assembly 280), whereby mechanisms 269 and 279 may be configured to interact with each other in any suitable manner(s) for selectively enabling either retained contact between the mechanisms or allowable disconnect of one mechanism from the other. For example, mechanisms 269 and 279 may be magnets whereby a north pole of one magnet may face and attract the south pole of the other magnet for holding mechanisms 269 and 279 together when tray 270 is to be held in its upright position, and where the force may be configured to be strong enough to hold tray 270 in its upright position during most uses of vehicle 290 but may not be strong enough to prevent a user from pulling mechanisms 269 and 279 apart such that hinge assembly 280 may allow for movement of tray 270 from its upright position to one or more possible open positions (e.g., for supporting any suitable user item in an open and substantially flat position of the tray). As another example, mechanisms 269 and 279 may be any suitable latch system, any suitable snap system, any suitable hook-and-loop fastener system (e.g., Velcro™), and/or any other suitable coupling/decoupling mechanisms. In some embodiments, any suitable lock apparatus 269k may be provided with respect to mechanisms 269 and 279 for preventing pulling mechanisms 269 and 279 apart unless the lock has been unlocked, which may enable a heightened security feature for protecting any user device that may be held within space 260s behind tray 270 in its upright and locked position (e.g., a lock with manual physical key, a lock with a digital code, etc.).

Tray component 270 may be made of any suitable material, such as a material that may be strong enough to support any suitable user items when the tray is in its open and flat position. In some embodiments, tray component 270 may be transparent or may have an opacity less than 100% such that a passenger may be able to view a user device within compartment 260 (e.g., view a display screen of device 220u) through tray 270 when tray 270 is in its upright position (see, e.g., FIG. 2R, where tray 270 may be in its upright position and yet user device 220u may be at least partially visible through tray 270). Tray component 270 may be made of any suitable material or combination of materials, including, but not limited to, any suitable plastics, polypropylene, acrylonitrile butadiene styrene, acrylic, nylon, tempered glass, polyoxymethylene, and/or the like. A permanent or removable or retractable mat may be provided on a top surface of tray component 270 for providing a nonslip surface for preventing unwanted movement of object(s) positioned on the tray, and/or a liner for providing a barrier for food particles into the tray and/or for providing security when used to prevent unwanted visibility of a user device through the tray.

Additionally or alternatively, whether or not a user device is positioned within compartment 260 of system 291, any suitable mechanism(s) may be provided for holding tray component 270 in a fully open position (see, e.g., position 270-3 of FIG. 2O and FIG. 2T) that may allow tray component 270 to extend along a rear surface of the seat (e.g., such that tray 270 may be held open so as not to extend into a passenger's lap space (e.g., one or more positions between position 270-2 and position 270-3 that might interfere with the legs of a passenger (e.g., passenger 215ra))) and for selectively releasing tray component 270 from such a fully open position. For example, as shown, any suitable seat retention mechanism 268 may be provided along a portion of seat 214fa (e.g., below compartment 260), while any suitable tray retention mechanism 278 may be provided at or near a portion of bottom surface 270b of tray 270 (e.g., at or near a free end 271 of tray 270 opposite hinge assembly 280), whereby mechanisms 268 and 278 may be configured to interact with each other in any suitable manner(s) for selectively enabling either retained contact between the mechanisms or allowable disconnect of one mechanism from the other. For example, mechanisms 268 and 278 may be magnets whereby a north pole of one magnet may face and attract the south pole of the other magnet for holding mechanisms 268 and 278 together when tray 270 is to be held in its fully open position, and where the force may be configured to be strong enough to hold tray 270 in its fully open position during most uses of vehicle 290 but may not be strong enough to prevent a user from pulling mechanisms 268 and 278 apart such that hinge assembly 280 may allow for movement of tray 270 from its fully open position to one or more possible other positions (e.g., for supporting any suitable user item in an open and substantially flat position of the tray or for its fully upright position). As another example, mechanisms 268 and 278 may be any suitable latch system, any suitable snap system, any suitable hook-and-loop fastener system (e.g., Velcro™), and/or any other suitable coupling/decoupling mechanisms.

In some embodiments, device holder system 291 may include a protective tray cover 240 that may be movable between and held in various positions (e.g., using any suitable hinge assembly 284) for reconfiguring system 291 between various configurations, such as a first or closed configuration in which protective tray cover 240 may be in an upright position whereby tray cover 240 (e.g., a top surface 240t of cover 240) may extend along bottom surface 270b of tray 270 such that tray 270 may be covered by cover 240 no matter what position tray 270 may be in (see, e.g., FIGS. 2P, 2Q, and 2S), a second or open configuration in which protective tray cover 240 may be in an open position whereby tray cover 240 (e.g., top surface 240t of cover 240) may not extend along bottom surface 270b of tray 270 such that tray 270 may not be covered by cover 240 no matter what position tray 270 may be in (see, e.g., FIG. 2R), and/or any other configurations therebetween. Hinge assembly 284 may be any suitable assembly that may be operative to enable movement of tray cover 240 between its various positions. Tray cover 240 may be made of any suitable material(s), such as a material that may be opaque enough to prevent a user device within compartment 260 to be seen through tray 270 and through cover 240 (e.g., to prevent a would be thief from seeing a user device within compartment 260 if tray 270 were in its fully upright position and tray cover 240 were in its closed configuration (see, e.g., FIG. 2S)) and/or that may be rigid enough to enable easy movement between the various cover positions. Tray cover 240 may be made of any suitable material or combination of materials, including, but not limited to, any suitable plastics, polypropylene, acrylonitrile butadiene styrene, and/or the like.

Whether or not tray component 270 is in its fully upright position or its fully closed position or any position therebetween, any suitable mechanism(s) may be provided for holding tray cover 240 in a closed position (see, e.g., FIGS. 2P, 2Q, and 2S) that may allow tray cover 240 to cover at least some of tray 270 and for selectively releasing tray cover 240 from such a closed position. For example, as shown, any suitable cover retention mechanism 247 may be provided at or near a portion of top surface 240t of cover 240 (e.g., at or near a free end 241 of cover 240 opposite hinge assembly 284), while any suitable tray retention mechanism 277 may be provided at or near a portion of bottom surface 270b of tray 270 (e.g., at or near a free end 271 of tray 270 opposite hinge assembly 280 but more proximal to hinge assembly 280 than retention mechanism 278 may be to hinge assembly 280), whereby mechanisms 247 and 277 may be configured to interact with each other in any suitable manner(s) for selectively enabling either retained contact between the mechanisms or allowable disconnect of one mechanism from the other. For example, mechanisms 247 and 277 may be magnets whereby a north pole of one magnet may face and attract the south pole of the other magnet for holding mechanisms 247 and 277 together when cover 240 is to be held in its closed position, and where the force may be configured to be strong enough to hold cover 240 in its closed position during most uses of vehicle 290 but may not be strong enough to prevent a user from pulling mechanisms 247 and 277 apart such that hinge assembly 284 may allow for movement of cover 240 from its closed position to its open position. As another example, mechanisms 247 and 277 may be any suitable latch system, any suitable snap system, any suitable hook-and-loop fastener system (e.g., Velcro™), and/or any other suitable coupling/decoupling mechanisms. Alternatively, in some embodiments, cover 240 may be configured to be opened and closed via a roller mechanism or a slider mechanism such that the cover may be partially rolled or slid back for selectively covering a portion of the tray.

Additionally or alternatively, any suitable mechanism(s) may be provided for holding tray cover 240 in a fully open position that may allow tray cover 240 to extend along a rear surface of the seat (e.g., such that tray cover 240 may be held open so as not to extend into a passenger's lap space (see, e.g., FIG. 2R)) and for selectively releasing tray cover 240 from such a fully open position. For example, as shown, any suitable seat retention mechanism 263 may be provided along a portion of seat 214fa (e.g., below compartment 260 (e.g., but above mechanism 268)), while any suitable tray cover retention mechanism 246 may be provided at or near a portion of bottom surface 240b of tray cover 240 (e.g., at or near free end 241 of tray cover 240 opposite hinge assembly 284), whereby mechanisms 263 and 246 may be configured to interact with each other in any suitable manner(s) for selectively enabling either retained contact between the mechanisms or allowable disconnect of one mechanism from the other. For example, mechanisms 263 and 246 may be magnets whereby a north pole of one magnet may face and attract the south pole of the other magnet for holding mechanisms 263 and 246 together when tray cover 240 is to be held in its fully open position, and where the force may be configured to be strong enough to hold tray cover 240 in its fully open position during most uses of vehicle 290 but may not be strong enough to prevent a user from pulling mechanisms 263 and 246 apart such that hinge assembly 284 may allow for movement of tray cover 240 from its fully open position to one or more possible other positions. As another example, mechanisms 263 and 246 may be any suitable latch system, any suitable snap system, any suitable hook-and-loop fastener system (e.g., Velcro™), and/or any other suitable coupling/decoupling mechanisms.

In some embodiments, as shown, a bottom surface 240b of tray cover 240 may include or provide or be coupled to a mirror component 240m that may provide any suitable reflective surface, such that, when tray 270 is in its fully upright position and cover 240 is in its closed configuration (see, e.g., FIG. 2S), mirror component 240m may be used by a passenger (e.g., passenger 215ra) to see their reflection. Therefore, in such embodiments, device holder system 291 may include a protective mirror cover 250 that may be movable between and held in various positions (e.g., using any suitable hinge assembly 288) for reconfiguring system 291 between various configurations, such as a first or closed configuration in which protective mirror cover 250 may be in an upright position whereby mirror cover 250 (e.g., a top surface 250t of cover 250) may extend along bottom surface 240b of tray cover 240 such that mirror component 240m of tray cover 240 may be covered by mirror cover 250 no matter what position tray cover 240 may be in (see, e.g., FIGS. 2P, 2Q, 2R, and 2T), a second or open configuration in which protective mirror cover 250 may be in an open position whereby mirror cover 250 (e.g., top surface 250t of cover 250) may not extend along bottom surface 240b of tray cover 240 such that mirror component 240m of tray cover 240 may not be covered by mirror cover 250 no matter what position tray cover 240 may be in (see, e.g., FIG. 2S), and/or any other configurations therebetween. Hinge assembly 288 may be any suitable assembly that may be operative to enable movement of mirror cover 250 between its various positions. Mirror cover 250 may be made of any suitable material(s), such as a material that may be opaque enough to prevent mirror component 240m to be seen through mirror cover 250 (e.g., to prevent a passenger from seeing an unwanted reflection (see, e.g., FIG. 2P)) and/or that may be rigid enough to enable easy movement between the various cover positions.

Whether or not tray cover 240 is in its open or closed position or any position therebetween, any suitable mechanism(s) may be provided for holding mirror cover 250 in a closed position (see, e.g., FIGS. 2P, 2Q, 2R, and 2T) that may allow mirror cover 250 to cover at least some of mirror component 240m of tray cover 240 and for selectively releasing mirror cover 250 from such a closed position. For example, as shown, any suitable mirror cover retention mechanism 256 may be provided at or near a portion of top surface 250t of mirror cover 250 (e.g., at or near a free end 251 of cover 250 opposite hinge assembly 288), while any suitable tray cover retention mechanism, such as mechanism 246, may be provided at or near a portion of bottom surface 240b of tray cover 240, whereby mechanisms 246 and 256 may be configured to interact with each other in any suitable manner(s) for selectively enabling either retained contact between the mechanisms or allowable disconnect of one mechanism from the other. For example, mechanisms 246 and 256 may be magnets whereby a north pole of one magnet may face and attract the south pole of the other magnet for holding mechanisms 246 and 256 together when cover 250 is to be held in its closed position, and where the force may be configured to be strong enough to hold cover 250 in its closed position during most uses of vehicle 290 but may not be strong enough to prevent a user from pulling mechanisms 246 and 256 apart such that hinge assembly 288 may allow for movement of cover 250 from its closed position to its open position. As another example, mechanisms 246 and 256 may be any suitable latch system, any suitable snap system, any suitable hook-and-loop fastener system (e.g., Velcro™), and/or any other suitable coupling/decoupling mechanisms. Alternatively, in some embodiments, cover 250 may be configured to be opened and closed via a roller mechanism or a slider mechanism such that the cover may be partially rolled or slid back for selectively covering a portion of the mirror component.

Additionally or alternatively, any suitable mechanism(s) may be provided for holding mirror cover 250 in a fully open position that may allow mirror cover 250 to extend along a rear surface of the seat (e.g., such that mirror cover 250 may be held open so as not to extend into a passenger's lap space (see, e.g., FIG. 2S)) and for selectively releasing mirror cover 250 from such a fully open position. For example, as shown, any suitable seat retention mechanism 263 may be provided along a portion of seat 214fa (e.g., below compartment 260 (e.g., but above mechanism 268)), while any suitable mirror cover retention mechanism 253 may be provided at or near a portion of bottom surface 250b of mirror cover 250 (e.g., at or near free end 251 of mirror cover 250 opposite hinge assembly 288), whereby mechanisms 253 and 263 may be configured to interact with each other in any suitable manner(s) for selectively enabling either retained contact between the mechanisms or allowable disconnect of one mechanism from the other. For example, mechanisms 253 and 263 may be magnets whereby a north pole of one magnet may face and attract the south pole of the other magnet for holding mechanisms 253 and 263 together when mirror cover 260 is to be held in its fully open position, and where the force may be configured to be strong enough to hold mirror cover 250 in its fully open position during most uses of vehicle 290 but may not be strong enough to prevent a user from pulling mechanisms 253 and 263 apart such that hinge assembly 288 may allow for movement of mirror cover 250 from its fully open position to one or more possible other positions. As another example, mechanisms 253 and 263 may be any suitable latch system, any suitable snap system, any suitable hook-and-loop fastener system (e.g., Velcro™), and/or any other suitable coupling/decoupling mechanisms.

While each device holder system may be shown to be incorporated into or otherwise provided by or coupled to the rear side of a back support portion of a seat (e.g., the rear side of back support portion 214bs of seat 214fa), any suitable portion(s) (e.g., compartment 260) or the entirety of a device holder system may alternatively be incorporated into or otherwise provided by or coupled to the rear side of a headrest portion of a seat (e.g., the rear side of headrest portion 214 hr of seat 214fa). Alternatively, a device holder system may alternatively be incorporated into or otherwise provided by or coupled to the interior side of any vehicle door or other interior vehicle wall of a vehicle (e.g., dashboard) that may be positioned opposite or in any other suitable position with respect to a passenger of the vehicle that may be able to use such a device holder system. In some embodiments, a device holder system may be incorporated into or otherwise provided by or coupled to any other suitable portion of a vehicle other than the rear of a passenger seat. For example, in order to provide functionality to a front passenger of a front seat (e.g., a passenger (not shown of front seat 214fa), a device holder system (e.g., similar to device holder system 291) may be incorporated into any suitable portion of a dashboard (e.g., dashboard 213 of vehicle 290), such as a portion above a glove compartment of the vehicle (e.g., as shown at dashboard portion 213d of dashboard 213 of FIG. 2B with a device holder system 291′).

A device holder system may be incorporated into or otherwise provided by or coupled to a rear side of a component of a vehicle such that the rear edges of a device compartment (e.g., of portions 264, 266, 265, 267, and/or the like) may be flush (e.g., continuous) with a surface of that rear side of the vehicle (e.g., surface 214fas of seat 214fa of FIG. 2O). In some embodiments, a device holder system may be incorporated into a vehicle such that the bottom surface of a tray (e.g., surface 270b) may be flush (e.g., continuous) with a surface of that rear side of the vehicle (e.g., surface 214fas of FIG. 2O) when the tray is in its fully upright position. Alternatively, a device holder system may be incorporated into a vehicle in any other suitable manner such that any other suitable feature(s) may be flush with the surface of the relevant surface(s) of the vehicle.

A device holder system may be moved or reoriented with a vehicle in any suitable manner for appropriately aligning with the needs of a passenger (e.g., as may vary with the size (e.g., height) of the passenger and/or with the position of the seat (e.g., seat 214fa by which the device holder system may be provided) with respect to the passenger). Any suitable support structure 216 may be provided by a relevant portion of the vehicle (e.g., by seat 214fa by which the device holder system may be provided) and at least a portion of the device holder system may be movably coupled to the support structure for enabling any suitable repositioning and/or reorientation of the device holder system with respect to the vehicle. For example, support structure 216 may be any suitable portion of seat 214fa (e.g., a metal support component running through an interior portion of back support portion 214bs of seat 214fa) and any suitable portion of device holder system 291 may be coupled to support structure 216 in any suitable manner via any suitable device holder connector(s) 217 for enabling relative movement therebetween. In some embodiments, connector(s) 217 may allow for vertical movement of compartment 260 along support 216 (e.g., in either vertical direction of arrow 217v (e.g., along a track provided by structure 216)), which may enable a user device 220u held within the compartment space to be repositioned to an appropriate height along the seat that may be best for the height of a passenger to be using the user device. Additionally or alternatively, connector(s) 217 may allow for rotational and/or tilting movement of compartment 260 with respect support 216 (e.g., in either tilt direction of arrow 217t (e.g., about a ball joint)), which may enable a user device 220u held within the compartment space to be repositioned to an appropriate angle with respect to the seat that may be best for the viewing angle of a passenger to be using the user device. In some embodiments, connector(s) 217 may be configured to adjust the position of compartment 260 with respect to support 216 automatically in response to movement of surface 214fas of seat 214fa with respect to a user 215ra and/or a user seat 214ra (e.g., any suitable processor may be programmed to automatically adjust the position of compartment 260 with respect to seat 214ra and/or user 215ra in response to a change in position of surface 214fas of seat 214fa with respect to user 215ra and/or user seat 214ra (e.g., to maintain a proper viewing position of a user device within space 260s and/or a functional position of tray 270 when open for use as a tray). One or more sensors of a user device and/or any other sensors of the vehicle or otherwise may be configured to determine the presence and/or height of a potential user to determine the appropriate position of compartment 260 and/or tray 270 with respect to that user.

In some embodiments, a device holder system may be removably coupled to a component of a vehicle (e.g., surface 214fas of seat 214fa or dashboard 213) using any suitable coupling apparatus (e.g., straps that may be wound about seat 214fa and through one or more slots in the device holder system for holding the holder system in a functional position with respect to the seat), whereby the device holder system may be sold separately from the vehicle or moved to be used with different seats at different times).

One, some, or all of the processes described with respect to FIGS. 1-2T may each be implemented by software, but may also be implemented in hardware, firmware, or any combination of software, hardware, and firmware. Instructions for performing these processes may also be embodied as machine- or computer-readable code recorded on a machine- or computer-readable medium. In some embodiments, the computer-readable medium may be a non-transitory computer-readable medium. Examples of such a non-transitory computer-readable medium include but are not limited to a read-only memory, a random-access memory, a flash memory, a CD-ROM, a DVD, a magnetic tape, a removable memory card, and a data storage device (e.g., memory 13 of a subsystem). In other embodiments, the computer-readable medium may be a transitory computer-readable medium. In such embodiments, the transitory computer-readable medium can be distributed over network-coupled computer systems so that the computer-readable code is stored and executed in a distributed fashion. For example, such a transitory computer-readable medium may be communicated from one subsystem to another directly or via any suitable network or bus or the like. Such a transitory computer-readable medium may embody computer-readable code, instructions, data structures, program modules, or other data in a modulated data signal, such as a carrier wave or other transport mechanism, and may include any information delivery media. A modulated data signal may be a signal that has one or more of its characteristics set or changed in such a manner as to encode information in the signal.

Any, each, or at least one module or component or subsystem of the disclosure may be provided as a software construct, firmware construct, one or more hardware components, or a combination thereof. For example, any, each, or at least one module or component or subsystem of system 1 may be described in the general context of computer-executable instructions, such as program modules, that may be executed by one or more computers or other devices. Generally, a program module may include one or more routines, programs, objects, components, and/or data structures that may perform one or more particular tasks or that may implement one or more particular abstract data types. The number, configuration, functionality, and interconnection of the modules and components and subsystems of system 1 are only illustrative, and that the number, configuration, functionality, and interconnection of existing modules, components, and/or subsystems may be modified or omitted, additional modules, components, and/or subsystems may be added, and the interconnection of certain modules, components, and/or subsystems may be altered.

As used in this specification and any claims of this application, the terms “base station,” “receiver,” “computer,” “server,” “processor,” and “memory” may all refer to electronic or other technological devices. These terms exclude people or groups of people. For the purposes of the specification, the terms “display” or “displaying” means displaying on an electronic device.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. The term “and/or” as used herein may refer to and encompass any and all possible combinations of one or more of the associated listed items. As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” may each refer to only A, only B, or only C; any combination of A, B, and C; and/or at least one of each of A, B, and C. The terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof. When used in the claims, the term “or” is used as an inclusive or and not as an exclusive or. For example, the phrase “at least one of x, y, or z” means any one of x, y, and z, as well as any combination thereof.

The term “if” may, optionally, be construed to mean “when” or “upon” or “in response to determining” or “in response to detecting,” depending on the context. Similarly, the phrase “if it is determined” or “if [a stated condition or event] is detected” may, optionally, be construed to mean “upon determining” or “in response to determining” or “upon detecting [the stated condition or event]” or “in response to detecting [the stated condition or event],” depending on the context.

As used herein, the terms “computer,” “personal computer,” “device,” “computing device,” “router device,” and “controller device” may refer to any programmable computer system that is known or that will be developed in the future. In certain embodiments, a computer may be coupled to a network, such as described herein. A computer system may be configured with processor-executable software instructions to perform the processes described herein. Such computing devices may be mobile devices, such as a mobile telephone, data assistant, tablet computer, or other such mobile device. Alternatively, such computing devices may not be mobile (e.g., in at least certain use cases), such as in the case of server computers, desktop computing systems, or systems integrated with non-mobile components.

As used herein, the terms “component,” “module,” and “system” may be intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server may be a component. One or more components may reside within a process and/or thread of execution and a component may be localized on one computer and/or distributed between two or more computers.

The predicate words “configured to,” “operable to.” “operative to,” and “programmed to” do not imply any particular tangible or intangible modification of a subject, but, rather, are intended to be used interchangeably. In one or more implementations, a processor configured to monitor and control an operation or a component may also mean the processor being programmed to monitor and control the operation or the processor being operable to monitor and control the operation or the processor being operative to monitor and control the operation. Likewise, a processor configured to execute code can be construed as a processor programmed to execute code or operable to execute code or operative to execute code.

As used herein, the term “based on” may be used to describe one or more factors that may affect a determination. However, this term does not exclude the possibility that additional factors may affect the determination. For example, a determination may be solely based on specified factors or based on the specified factors as well as other, unspecified factors. The phrase “determine A based on B” specifies that B is a factor that is used to determine A or that affects the determination of A. However, this phrase does not exclude that the determination of A may also be based on some other factor, such as C. This phrase is also intended to cover an embodiment in which A may be determined based solely on B. As used herein, the phrase “based on” may be synonymous with the phrase “based at least in part on.”

As used herein, the phrase “in response to” may be used to describe one or more factors that trigger an effect. This phrase does not exclude the possibility that additional factors may affect or otherwise trigger the effect. For example, an effect may be solely in response to those factors, or may be in response to the specified factors as well as other, unspecified factors. The phrase “perform A in response to B” specifies that B is a factor that triggers the performance of A. However, this phrase does not foreclose that performing A may also be in response to some other factor, such as C. This phrase is also intended to cover an embodiment in which A is performed solely in response to B.

Phrases such as an aspect, the aspect, another aspect, some aspects, one or more aspects, an implementation, the implementation, another implementation, some implementations, one or more implementations, an embodiment, the embodiment, another embodiment, some implementations, one or more implementations, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration”. Any embodiment described herein as “exemplary” or as an “example” is not necessarily to be construed as preferred or advantageous over other implementations. Furthermore, to the extent that the term “include,” “have,” or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for”.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more”. Unless specifically stated otherwise, the term “some” refers to one or more. Pronouns in the masculine (e.g., his) include the feminine and neuter/neutral gender (e.g., her and its and they) and vice versa. Headings and subheadings, if any, are used for convenience only and do not limit the subject disclosure.

While there have been described device holders for the backs of vehicle seats and methods for using the same, many changes may be made therein without departing from the spirit and scope of the subject matter described herein in any way. Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements. It is also to be understood that various directional and orientational terms, such as “left” and “right,” “up” and “down,” “front” and “back” and “rear,” “top” and “bottom” and “side,” “above” and “below,” “length” and “width” and “thickness” and “diameter” and “cross-section” and “longitudinal,” “X-” and “Y-” and “Z-,” and/or the like, may be used herein only for convenience, and that no fixed or absolute directional or orientational limitations are intended by the use of these terms. For example, the components of the apparatus can have any desired orientation. If reoriented, different directional or orientational terms may need to be used in their description, but that will not alter their fundamental nature as within the scope and spirit of the disclosure.

Therefore, those skilled in the art will appreciate that the concepts of the disclosure can be practiced by other than the described embodiments, which are presented for purposes of illustration rather than of limitation.

What is claimed is:

1. A device holder system of a vehicle for use with a portable user device, the device holder system comprising:
a device compartment at least partially defining a device space;
a tray component coupled to the device compartment and movable between at least:
a first position wherein the tray component at least partially covers an opening of the device space; and
a second position wherein the tray component does not cover the opening of the device space; and
an electrical connector that is configured to electrically couple with the portable user device, wherein the electrical connector is coupled to the device compartment and accessible within the device space when the tray component is in the second position.

2. The device holder system of claim 1, wherein the electrical connector comprises a Universal Serial Bus (“USB”) connector.

3. The device holder system of claim 1, wherein the electrical connector comprises an inductive charging pad.

4. The device holder system of claim 1, wherein the electrical connector is configured to electrically couple with the portable user device for charging the portable user device with a power supply of the vehicle.

5. The device holder system of claim 1, wherein the electrical connector is configured to electrically couple with the portable user device for communicatively coupling the portable user device with a processor of the vehicle.

6. The device holder system of claim 1, wherein the device space is not accessible when the tray component is in the first position.

7. The device holder system of claim 1, wherein the tray component provides a flat table surface when the tray component is in the second position.

8. The device holder system of claim 7, wherein the tray component is movable between at least:
the first position;
the second position; and
a third position opposite the first position.

9. The device holder system of claim 1, further comprising a device holding feature coupled to the device compartment and configured to selectively retain the user device within the device space.

10. The device holder system of claim 1, wherein the device holding feature comprises a spring loaded tab.

11. The device holder system of claim 1, wherein the tray component is at least partially transparent for enabling a user to see into the device space through the tray component when the tray component is in the first position.

12. The device holder system of claim 1, wherein the tray component is at least partially opaque for preventing a user to see into the device space through the tray component when the tray component is in the first position.

13. The device holder system of claim 1, further comprising a locking mechanism configured to selectively lock the tray component in the first position.

14. The device holder system of claim 1, further comprising a device holder connector coupled to the device compartment and to a support structure of the vehicle.

15. The device holder system of claim 1, wherein the support structure is provided by a back support portion of a seat of the vehicle.

16. The device holder system of claim 15, wherein the tray component provides a flat table surface for a passenger of another seat behind the seat when the tray component is in the second position.

17. The device holder system of claim 1, wherein the support structure is provided by a dashboard of the vehicle.

18. The device holder system of claim 17, wherein the tray component provides a flat table surface for a passenger of a front seat of the vehicle when the tray component is in the second position.

19. A device holder system comprising:
a device compartment defining a device space;
a tray component movable between:
a first position preventing access to the device space; and
a second position enabling access to the device space; and
an electrical connector at least partially positioned within the device space.

20. A device holder system of a vehicle for use with a portable user device, the device holder system comprising:
a device compartment at least partially defining a device space;
a cover component coupled to the device compartment and operative to selectively cover an opening to the device space; and
an electrical connector within the device space.
